(19) United States
(12) Patent Application Publication
(10) Pub. No.: US 2004/0034146 A1
(43) Pub. Date: Feb. 19, 2004

(54) Polyurethane-polyacrylate hybrid coating compositions

(76) Inventors: Rolf Gertzmann, Leverkusen (DE); Joachim Petzoldt, Monheim (DE); Heino Muller, Leverkusen (DE)

Correspondence Address: BAYER POLYMERS LLC, 100 BAYER ROAD, PITTSBURGH, PA, 15205, US

(21) Appl. No.: 10/638,853

(22) Filed: Aug. 11, 2003

(30) Foreign Application Priority Data
Aug. 14, 2002 (DE) 10237193.8

(51) Int. Cl. C08L 1/00

(52) U.S. Cl. 524/457; 524/507

(57) ABSTRACT

Solvent-free aqueous polyurethane-polyacrylate hybrid dispersions, a process for preparing them and their use for producing elastic coatings. The polyurethane-polyacrylate hybrid dispersions are obtained by preparing a hydrophilic or hydrophilicizable polyurethane by reacting isocyanate components with an equimolar amount of one or more diols or polyols, low molecular weight diols or polyols, and hydrophilic compounds having at least one NCO-reactive group, in the presence of ethylenically unsaturated monomers which are inert towards NCO groups. The resulting NCO-free polyurethane is dispersed in emulsion-polymerizing monomers.

### CROSS REFERENCE TO RELATED PATENT APPLICATION

The present patent application claims the right of priority under 35 U.S.C. §119 (a)-(d) of German Patent Application No. 10237193.8, filed Aug. 14, 2002.

### BACKGROUND OF THE INVENTION

1. Field of the Invention

The present invention relates to new, solvent-free aqueous polyurethane-polyacrylate hybrid dispersions, to a process for preparing them and to their use for producing elastic coatings.

2. Description of the Related Art

Aqueous coating materials for the temporary protection of high-grade products, such as glass, metal and plastic, against mechanical damage or environmental effects are known. The aqueous, solvent-free dispersions are applied by rolling or spraying, for example, and then form films. The resultant continuous film can be stripped off easily later as a coherent film and recycled or incinerated. This technique is especially suitable for protecting surfaces of motor vehicles and plastics and also electronic appliances and fitments.

Polyurethanes feature very good mechanical properties, achieved by virtue of the physical crosslinking of individual polyurethane chains via hydrogen bonds (e.g. in G. Oertel, Polyurethane Handbook 2nd Edition, Carl Hanser Verlag, 1993, pp. 37-38). The mechanical properties of the polyacrylates are often inferior to those of the polyurethanes, but by producing polymer hybrids from urethanes and acrylates it is possible to prepare products having improved properties (e.g. in C. R. Hegedus, K. A. Kloiber J. Coatings Techn. 68 (860),1996, pp.39-48). Different preparation variants for this class of product are described in the patent literature.

In EP-A 167 188, for example, a process for preparing aqueous polyurethane-polyacrylate hybrids is disclosed in which hydrophilicized NCO prepolymers are prepared but contain partially terminal polymerizable double bonds introduced by way of hydroxy-functional (meth)acrylates. Chain extension of the NCO groups and/or of the polyurethane chains containing terminal, vinylic double bonds takes place in the aqueous phase by way of free NCO groups, by adding amino-functional compounds. The aqueous dispersions containing double bonds are polymerized following chain extension, by adding corresponding initiators and, where appropriate, further polymerizable monomers. A disadvantage is that in addition to the chain extension by way of the amines there is also a reaction of the free isocyanate groups with water that is virtually impossible to control, leading to a variety of problems, such as foaming and the formation of gel specks, for example.

Furthermore, owing to the NCO-water reaction, different urea structures are formed and, in association therewith, the adhesion properties of the coatings on the target substrate differ. Particularly during removal of the temporary coating there may be considerable problems.

JP-A 10 237 138 discloses a process for preparing polyurethane-polyacrylate hybrids wherein first of all a polyisocyanate with a polyol in the presence of unsaturated monomers an NCO-containing prepolymer is formed which in a second step is chain-extended in the presence of hydroxyl-functional, polymerizable monomers. In the two steps which follow this the solution is dispersed and polymerized. Owing to the polymerizable, terminal double bonds on the polymer chains, a subsequent polymerization leads to branched products. Such dispersions often display poor film-forming properties or tend to form gel specks.

In EP-A 189 945, NCO-containing prepolymers are prepared in the presence of inert, liquid, polymerizable, ethylenically unsaturated monomers. The monomers here serve first as reactive diluents in order to keep the viscosity of the hydrophilicized/hydrophilicizable prepolymer melt sufficiently low to allow the resin to be dispersed. Following transfer to the aqueous phase, the NCO prepolymer is chain-extended with amines. This is followed by the polymerization of the unsaturated monomers which are enclosed in the polyurethane particles. This process also involves dispersing an NCO prepolymer in water, and so here again there is an uncontrollable NCO-water reaction.

EP-A 353 797 discloses aqueous polyurethane-polyacrylate hybrid dispersions obtained by a two-stage preparation procedure. First of all, the polyurethane is obtained by reaction of polyisocyanates with hydroxyl-functional compounds containing an acid group and then carrying out reaction with polyols. The first reaction is carried out in the presence of acrylate and/or methacrylate monomers. The polyurethane-polyacrylate hybrid dispersion is prepared in situ by feeding the polymer solution to the emulsion polymerization procedure. This emulsion polymerization proceeds in aqueous phase with the addition of an external emulsifier.

### BRIEF SUMMARY OF THE INVENTION

It is an object of the present invention to provide aqueous, solvent-free and emulsifier-free polyurethane-polyacrylate hybrid dispersions from which it is possible to produce water-resistant and solvent-resistant coatings having high elongation at break and low hardness. The dispersions should also be able to be formulated to give strippable coating materials.

Surprisingly it has been found that in vinyl monomers as reactive diluents it is possible to prepare high molecular mass polyurethanes by reacting equimolar amounts of diisocyanates and OH/NH/NH₂-containing compounds and that this polymer solution, without chain extension and before or during dispersion, can be subsequently readily dispersed without any gelling. The polyurethane-polymer dispersions obtainable in this way can then be reacted by means of emulsion polymerization to form polyurethane-polyacrylate hybrid dispersions. The coatings produced with the dispersions of the invention are notable in particular for especially good elongation at break, tear propagation resistance and tensile strength.

The present invention accordingly provides a process for preparing, aqueous, emulsifier-free and solvent-free polyurethane-polyacrylate hybrid dispersions, comprising the steps of

(I) preparing a hydrophilic or hydrophilicizable polyurethane by reacting one or more isocyanate components (A) with one or more components (B) comprising

(B 1) one or more diols or polyols having a molecular weight of from 500 to 6000 and an OH functionality of from 1.8 to 5,

(B2) one or more low molecular weight diols or polyols of the molecular weight range from 62 to 400 with an OH functionality of two or more as chain extenders,

(B3) one or more hydrophilic compounds containing non-ionic groups and/or ionic and/or potentially ionic groups and having at least one NCO-reactive group,

(B4) if desired, polyamines and/or alkanolamines of the molecular weight range from 60 to 300 with an NH functionality of 2 or more,

(B5) if desired, monofunctional compounds of the molecular weight range from 17 to 350

in the presence of ethylenically unsaturated monomers (C1) which are inert towards NCO groups, with the proviso that components (A) and (B) are used so as to result in a ratio of NCO groups to OH/NH/NH₂ groups of 1:1,

(II) subsequently dispersing the polyurethane from (I) in water, and

(III) emulsion-polymerizing monomers (C) comprising ethylenically unsaturated monomers (C1) inert towards NCO groups and, where appropriate, ethylenically unsaturated monomers (C2) containing Zerevitinov-active hydrogen atoms.

The present invention likewise provides polyurethane-polyacrylate hybrid dispersions obtainable by the process of the invention. Preferred polyurethane-polyacrylate hybrid dispersions of the invention are free of urea groups.

### DETAILED DESCRIPTION OF THE INVENTION

As used herein, unless otherwise expressly specified, all of the numerical ranges, amounts, values and percentages such as those for amounts of materials, times and temperatures of reaction, ratios of amounts, values for molecular weight, and others in the following portion of the specification may be read as if prefaced by the word “about” even though the term “about” may not expressly appear with the value, amount or range.

Suitable isocyanate components (A) are diisocyanates (A1) and polyisocyanates (A2). Preferably, diisocyanates (A1) are used in the process of the invention. Suitable components (A1) are the aliphatic, cycloaliphatic, araliphatic and aromatic diisocyanates or mixtures thereof that are normally used in polyurethane chemistry. Particularly noteworthy are diisocyanates of the general formula (I)

R¹(NCO)₂ (I)

where

R¹ stands for an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms.

Examples of such diisocyanates (A1) for preferred use are 1,3-cyclohexane diisocyanates, 1-methyl-2,4-diisocyanatocyclohexane, 1-methyl-2,6-diisocyanatocyclohexane, tetramethylene diisocyanate, 4,4′-diisocyanatodiphenylmethane, 2,4′-diisocyanatodiphenylmethane, 2,4-diisocyanatotoluene, 2,6-diisocyanatotoluene or α,α,α′,α′-tetramethyl-m- or p-xylylene diisocyanates, and mixtures of the said diisocyanates. More preferred diisocyanates are 4,4′-diisocyanatodiphenylmethane, 2,4′-diisocyanatodiphenylmethane, 2,4-diisocyanatotoluene, 2,6-diisocyanatotoluene and mixtures of these. Diisocyanates likewise more preferred are 1,6-hexamethylene diisocyanates, 1-isocyanato-3,3,5-trimethyl-5-isocyanatomethylcyclohexane (isophorone diisocyanates) and 4,4′-diisocyanatodicyclohexylmethane and mixtures thereof.

In order to prepare polyurethanes having a certain degree of branching or crosslinking it is possible, where appropriate, to use, as components (A2), polyisocyanates having functionalities of more then 2 and less than 5 in amounts up to 10% by weight, preferably up to 5% by weight and more preferably up to 2% by weight based on the hydrophilicized polyurethane from stage (I). These isocyanates are obtained, for example, by reacting difunctional isocyanates with one another in such a way that some of their isocyanate groups are derivatized to form isocyanurate, iminooxadiazinedione, biuret, allophanate, uretdione or carbodiimide groups. Suitable polyisocyanates (A2) in this context may be aliphatic, cycloaliphatic, araliphatic and aromatic polyisocyanates or mixtures thereof. Preferred polyisocyanates (A2) are the aliphatic and cycloaliphatic products containing isocyanurate, iminooxadiazinedione, biuret, allophanate and/or uretdione groups.

As component (B1) use is made of polyols having a molecular weight of from 500 to 6000, preferably from 500 to 3000 and more preferably from 650 to 2500 which are normally used for preparing polyurethanes. They have an OH functionality of at least 1.8 to 5, preferably from 1.9 to 3 and more preferably from 1.93 to 2.0. They include, for example, polyesters, polyethers, polycarbonates, polyester-carbonates, polyacetals, polyolefins, polyacrylates and polysiloxanes. Preference is given to using α,Ω-diols of polyesters, polyethers based on propylene oxide or tetrahydrofuran, polyestercarbonates and polycarbonates. Particular preference is given to using polyesters based on adipic acid, 1,6-hexanediol and neopentyl-glycol.

Suitable components (B2) are short-chain diols (B2′) and polyols (B2″) having molar weights of below 500, preferably from 62 to 135, which are used as chain extenders. In the process of the invention it is preferred to use diols (B2′). Suitable diols (B2′) include the diols customary in polyurethane chemistry, such as ethylene glycol, 1,2- and 1,3-propanediol, 1,3- and 1,4-butanediol, 1,6-hexanediol, 2-ethyl-1,3-hexanediol, diethylene glycol, dipropylene glycol, neopentylglycol, 2,4-dimethylpentanediol, 2-ethyl-3-propyl-1,5-pentanediol, 2,2,4-trimethylpentanediol, cyclohexanedimethanol or mixtures of such diols. 1,4-Butanediol, 1,6-hexanediol and neopentylglycol are preferred. Where appropriate it is also possible to add short-chain polyols (B2″) such as, for example, trimethylol-propane, glycerol, hexanetriol, pentaerythritol and N,N′,N″-tris(2-hydroxyethyl) isocyanurate in amounts up to 4% by weight, preferably up to 3% by weight and more preferably up to 2% by weight based on the polyurethane from step (I). Preference is given to using trifunctional components such as trimethlyolpropane, for example.

Suitable components (B3) are ionic or potentially ionic compounds (B3′) and non-ionic compounds (B3″) which contain at least one NCO-reactive group. The use of ionic or potentially ionic compounds (B3′) in the process of the invention is preferred. Suitable compounds (B3′) are, for example, mono- and dihydroxy-carboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as, for example, dimethylolpropionic acid or dimethylolbutanoic acid, hydroxypivalic acid, N-(2-aminoethyl)-β-alanine, 2-(2-aminoethyl-amino)ethanesulphonic acid, ethylenediamine-propyl- or ethylenediamine-butylsulphonic acid, 1,2- or 1,3-propylenediamine-β-ethylsulphonic acid, lysine or 3,5-diaminobenzoic acid. Likewise suitable is the hydrophilicizing agent according to Example 1 from EP-A 0 916 647 and its alkali metal and/or ammonium salts, the adduct of sodium bisulphite with but-2-ene-1,4-diol, polyethersulphonate, the propoxylated adduct of 2-butenediol and NaHSO₃ (e.g. in DE-A 24 46 440, page 5-9, formula I-III) and also building blocks which can be converted into cationic groups, such as N-methyldiethanolamine.

Preferred ionic or potential ionic compounds (B3′) are those which possess carboxy and/or carboxylate and/or sulphonate groups and/or amine and/or ammonium groups. Particularly preferred ionic compounds (B3′) are those containing carboxylate and/or sulphonate groups as ionic or potentially ionic groups, such as the salts of N-(2-aminoethyl)-β-alanine, 2-(2-aminoethyl-amino)ethanesulphonic acid or of the hydrophilicizing agent according to Example 1 from EP-A 0 916 647 and also of dimethylolpropionic acid and dimethylobutyric acid.

Where appropriate it is also possible to use nonionically hydrophilic compounds (B3″), for example polyoxyalkylene ethers containing at least one hydroxyl or amino group in amounts of up to 20% by weight, preferably up to 10% by weight and more preferably up to 5% by weight, based on the polyurethane from step (I). These polyethers include a fraction of from 30% by weight to 100% by weight of building blocks derived from ethylene oxide. Suitable such polyethers include linear polyethers with a functionality of between 1 and 3, but also compounds of the general formula (II),

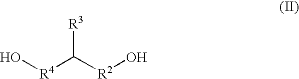

in which

R² and R⁴ independently of one another each denote a divalent aliphatic, cycloaliphatic or aromatic radical having 1 to 18 carbon atoms which can be interrupted by oxygen and/or nitrogen atoms and

R³ stands for a non-hydroxy-terminated polyester or, preferably, polyether. With particular preference R³ stands for an alkoxy-terminated polyethylene oxide radical.

Preferred hydrophilicizing agents (B3″) are monofunctional polyethers having ethylene oxide contents of more than 30% by weight.

Suitable components (B4) include polyfunctional, nitrogen-containing compounds that are reactive with isocyanates by way of NH groups, such as polyamines and alkanolamines, for example. Suitable such compounds include dietheylenetriamine, triethylenetetraamine and 4-aminomethyl-1,8-octanediamine. Preference is given to difunctional primary or secondary diamines such as ethylenediamine, propylenediamine, hexamethylenediamine, 2-methyl-1,5-diaminopentane, isophoronediamine, p-xylylenediamine, 4,4′-diaminodicyclohexylmethane and 4,4′-diamino-3,3′-dimethyldicyclo-hexylmethane or mixtures thereof. Particular preference is given to amino alcohols such as 2-aminoethanol, aminopropanol, 3-amino-1,2-propanediol, aminobutanols, 1,3-diamino-2-propanol, bis(2-hydroxypropyl)amine and propanolamine 1,1′-dimethyl-1,1′-dipropyl-2,2′iminodiethanol, 2-[(2-hydroxyethyl)amino-2-methylpropan-1-ol, 1-(2-hydroxyethyl)amino-2-propanol and 3,3′-diallyloxy-2,2′-dihydroxy-dipropylamine. Very particular preference is given to those Michael adducts which are obtained by reacting difunctional primary amines with maleic diesters and are referred to as aspartic esters. Aspartic esters of this kind are described in, for example, EP-A 403 921, p. 4 line 21-p. 5, line 7.

Suitable monofunctional compounds (B5), whose use is optional, are monofunctional alcohols, amines and ammonia, which can be used in amounts up to 10% by weight, preferably up to 8% by weight and more preferably up to 3% by weight based on the polyurethane from step (I). Examples that may be mentioned of primary and secondary amines include ethylamine, propylamine, isopropylamine and also their higher homologs, morpholine, diethylamine, diisopropylamine, methylethylamine and also higher homologues. Suitable amines likewise include addition compounds of primary amines with vinylogous systems such as, for example, (meth-)acrylates, as are obtained by Michael addition. Particularly suitable are those Michael adducts obtained by reacting monofunctional, primary amines with maleic diesters, these adducts being referred to as aspartic esters. Aspartic esters of this kind are described in, for example, EP-A 403 921, p. 4, line 21-p. 5, line 7. Preferred components (B5) are monofunctional alcohols such as methanol, ethanol, 1-propanol, 2-propanol and higher homologs and also mixtures thereof.

As component (C) it is possible to use polymerizable compounds containing vinylic unsaturation. A distinction is made here between ethylenically unsaturated monomers which are inert towards NCO groups (C1) and ethylenically unsaturated monomers that contain Zerevitinov-active hydrogen atoms (C2). From 50 to 100% by weight, preferably from 60 to 100% by weight and more preferably from 70 to 100% by weight of component (C) is made up of (C1). The fraction which makes this figure up to 100% corresponds to the amount of (C2). Zerevitinov active hydrogen atoms are hydrogen atoms which are attached to an oxygen, sulphur and/or nitrogen atom, such as —OH, —SH, ═NH and —NH₂, for example.

Suitable components (C1) are nonionically hydrophilicized acrylates or methacrylates, such as methoxypolyethylene glycol acrylate or methacrylate, for example, or bisacrylates or bismethacrylates, such as hexanediol diacrylate or methacrylate, ethylene glycol di(meth)acrylates, oligo- and polyethylene glycol di(meth)acrylates, for example, which can be used in small amounts up to 10% by weight, preferably up to 6% by weight and more preferably up to 3% by weight based on component (C). Likewise suitable are vinylically unsaturated polymerizable monomers such as, for example, vinyl esters, vinyl chloride, vinyl methyl ether, vinyl isobutyl ether, 2-ethylhexyl vinyl ether, acrylamides and methacrylamides. Preferred monomers are C₁-C₁₀ alkyl esters and C₅-C₁₀ cycloalkyl esters of acrylic and methacrylic acid such as, for example, methyl, ethyl, n-propyl, isopropyl, n-butyl, isobutyl, tert-butyl, hexyl, cyclohexyl, isobomyl and 2-ethylhexyl acrylate or methacrylate. Likewise suitable are compounds containing further functional groups, such as acetoacetoxy groups. Mixtures of the said monomers are likewise suitable. Preference is additionally given to aromatic compounds such as styrene, methylstyrene, vinyltoluene, divinylbenzene or mixtures thereof.

Suitable components (C2) are compounds such as, for example, itaconic, maleic or fumaric acid and also monoesters of the unsaturated C₄-C₈ dicarboxylic acids. These also include sulfonic acid radicals, such as that of 2-acrylamido-2-methylpropanesulfonic acid, for example. These compounds or mixtures thereof can be used in small amounts up to 5% by weight, preferably up to 3% by weight and more preferably up to 2% by weight, based on component (C). Preference is given to acrylic acid and methacrylic acid, which can be used in small amounts up to 5% by weight, preferably up to 3% by weight and more preferably up to 2% by weight, based on component (C). Particularly preferred components (C2) are hydroxyl-functional acrylates and methacrylates or mixtures thereof, examples being hydroxyethyl, hydroxypropyl and hydroxybutyl acrylate or the corresponding methacrylates. They are used in amounts of from 0 to 50% by weight, preferably from 0.5 to 30% by weight and more preferably from 1.0 up to 20% by weight, based on component (C).

It is possible to prepare the polyurethanes from step (I) of the process of the invention either free of urea groups or containing urea groups.

Preference is given to the preparation of a polyurethane which is free from urea groups in step (I) of the process of the invention, in which

from 15 to 65% by weight, preferably from 17 to 55% by weight, more preferably from 20 to 50% by weight of component (A1),

from 20 to 70% by weight, preferably from 25 to 65% by weight, more preferably from 30 to 60% by weight of the polymeric diols (B 1),

from 1 to 25% by weight, preferably from 3 to 18% by weight, more preferably from 5 to 18% by weight of component (B2′),

from 2 to 15% by weight, preferably from 3 to 12% by weight, more preferably from 3 to 10% by weight of component (B3′),

from 0 to 2.0% by weight, preferably from 0.2 to 2.0% by weight, more preferably from 0.5 to 1.5% by weight of component (B5)

are used, the percentages stated adding up to 100.

Likewise possible is the preparation of a polyurethane that contains urea groups in step (I) of the process of the invention, in which

from 15 to 65% by weight, preferably from 17 to 55% by weight, more preferably from 20 to 50% by weight of component (A1),

from 20 to 70% by weight, preferably from 25 to 65% by weight, more preferably from 30 to 60% by weight of the polymeric diols (B1),

from 1 to 25% by weight, preferably from 3 to 18% by weight, more preferably from 5 to 18% by weight of component (B2′),

from 2 to 15% by weight, preferably from 3 to 12% by weight, more preferably from 3 to 10% by weight of component (B3′),

from 0.1 to 25% by weight, preferably from 0.5 to 18% by weight, more preferably from 1.0 to 10% by weight of component (B4),

from 0 to 2.0% by weight, preferably from 0.2 to 2.0% by weight, more preferably from 0.5 to 1.5% by weight of component (B5)

are used, the percentages stated adding up to 100.

Here, in accordance with the invention, the average functionality of the raw materials used in step (I) should be 2.0, which means that in the case of optional use of (A2), (B2″) and/or polyols (B1) an equivalent amount of monofunctional components (B5) must be added so as to result in an average functionality of 2.0. Particularly preferred compositions are those in which only difunctional components are used in step (I).

In step (I) of the process of the invention the addition of the components (B) to component (A) is followed, preceded, or, preferably, accompanied by the addition of component (C1), which acts as a reactive diluent and can be used to lower the viscosity of the resin mixture to a desired level. The ethylenically unsaturated monomers (C1) which are inert towards NCO groups are used in amounts of from 6 to 90% by weight, preferably from 10 to 50% by weight, with particular preference from 15 to 25% by weight based on the resin solids of the hybrid dispersion of the invention.

In any case, the amount of (C1) acting as reactive diluent is to be such that, following the dispersing operation, these monomers can still be polymerized controllably in stage (III) of the process of the invention before any further monomers (C) are added.

Before the dispersing operation (stage (II)) of the process of the invention it is preferred to add a neutralizing agent (D) to the polyurethane resin in a temperature range from 40° to 95° C., preferably from 50° C. to 80° C. and more preferably from 50° C. to 70° C. and in an amount such that theoretically from 50 to 120%, preferably from 60 to 105% and more preferably from 70 to 100% of the acid groups are neutralized. It is assumed here that 1 mol of added neutralizing agent (D) generates ionic groups quantitatively. The neutralized polymer is supplied with vigorous stirring to a reservoir of water conditioned at between 10 and 80° C., preferably from 20 to 50° C. and more preferably from 20 to 40° C. and so is dispersed. It is likewise possible to supply the water to the resin with vigorous stirring.

The dispersing (stage (II)) of the hydrophilic or hydrophilicizable polyurethane from stage (I) of the process of the invention takes place by transferring the polyurethane to water or water is supplied to the solution of polyurethane in monomers (C1). The amount of water is such that the polyurethane-polyacrylate hybrid dispersions of the invention have a solids content of from 35 to 60% by weight, preferably from 35 to 50% by weight and more preferably from 38 to 50% by weight.

Suitable neutralizing agents (D) are alkaline organic and/or alkaline inorganic compounds. Besides aqueous ammonia, ethylamine and dimethylamine solution, volatile primary, secondary and tertiary amines, such as dimethylethanolamine, morpholine, N-methylmorpholine, piperidine, diethanolamine, triethanolamine, diisopropylamine, 2-amino-2-methylpropanol and 2-N,N-dimethylamino-2-methylpropanol or mixtures of these compounds are preferred. Particular preference is given to tertiary amines which are unreactive towards isocyanates, such as triethylamine, diisopropylethylamine and N-methylmorpholine, for example. Mixtures of neutralizing amines are likewise suitable.

The dispersing of the polyurethane in water may be preceded or followed where appropriate by the addition of further ethylenically unsaturated monomers (C1) which are inert towards NCO groups and, where appropriate, ethylenically unsaturated monomers (C2) containing Zerevitinov-active hydrogen atoms.

In stage (III) of the process of the invention the monomers (C) are polymerized by running in an initiator (E). In the course of stage (III), further monomers (C) are preferably metered in and polymerized. With particular preference, first of all the monomers (C1) added in stage (I) are polymerized and further monomers (C) are added and polymerized. The ratio of polyurethane polymer to polyacrylate polymer should be situated within the range from 20:80 to 90:10, preferably from 25:75 to 80:20 and more preferably from 30:70 to 70:30. Where appropriate, further water may be added before or during step (III).

In stage (III) of the process of the invention the dispersion, depending on the initiator (E) used, is conditioned to from 30 to 95° C., preferably from 50 to 90° C. and more preferably from 50 to 85° C. and, when using a redox initiator system, to from 30 to 70° C., preferably from 40 to 60° C., before the initiator is metered in in the manner of an emulsion polymerization in such a way that the rate of reaction can be controlled. Reactions of this kind are known to the person skilled in the art from the prior art and are described, for example, in Houben-Weyl, Methoden der org. Chemie, Volume E 20/1, Makromolekulare Stoffe, Georg-Thieme-Verlag, Stuttgart, 1987, pp. 218-226.

The initiator (E) is preferably metered beyond the end (generally from 30 to 90 minutes) of the monomer feed in order to ensure complete reaction of the monomers.

Examples of suitable polymerization initiators (E) are initiators which form free radicals, such as dialkyl peroxides, e.g. di-tert-butyl peroxide or dicumyl peroxide; hydroperoxides or tert-butyl hydroperoxide; peresters, such as tert-butyl perbenzoate, tert-butyl per-3,5,5-trimethylhexanoate or tert-butyl per-2-ethylhexanoate; potassium, sodium or ammonium peroxodisulphate; azo dinitriles such as azobisisobutyronitrile or 4,4′-azobis-4-cyanopentanoic acid; C-C-cleaving initiators such as benzpinacol silyl ethers or combinations of a non-oxidizing initiator with hydrogen peroxide. It is preferred to use water-soluble initiators, such as potassium, sodium or ammonium peroxodisulphate or 4,4′-azobis-4-cyanopentanoic acid, for example.

In order to suppress premature, thermally initiated polymerization of the added reactor diluent (C1) in step (I) of the process of the invention, polymerization inhibitors (F) are added in an amount of from 0.05 to 0.6% by weight, preferably from 0.1 to 0.5% by weight based on the amount of polymerizable components (C1). Such inhibitors are described, for example, in Houben-Weyl, Methoden der organischen Chemie, 4th Edition, Volume XIV/1, Georg Thieme Verlag, Stuttgart 1961, page 433 ff. Examples include the following: sodium dithionite, sodium hydrogen sulphide, sulphur, hydrazine, phenylhydrazine, hydrazobenzene, N-phenyl-β-naphthylamine, N-phenylethanoldiamine, dinitrobenzene, picric acid, p-nitrosodimethylaniline, diphenylnitrosamine, phenols, such as p-tert-butylpyrocatechol, 2,5-di-tert-amylhydroquinone, nitroxyl compounds, p-alkoxyphenols, di-tert-butylhydroquinone, tetramethylthiuram disulphide, 2-mercaptobenzothiazole and sodium dimethyldithiocarbamate. Preference is given to phenols.

It is likewise possible to carry out the process of the invention in the form of the seed/feed process, in which first 1/10 to 1/30 of the polyurethane dispersion from step (II), where appropriate with a further quantity of water, is introduced as an initial charge and is polymerized with a portion of the initiator (E). Following this, or after a certain time, the remaining PU dispersion from step (II), where appropriate with further monomers (C1) and (C2), is metered in in parallel with the in running initiator (E) at polymerization temperatures between 30 to 95° C., preferably from 50 to 90° C. and more preferably from 50 to 85° C., when using a redox initiator system from 30 to 70° C., preferably from 40 to 60° C.

In one preferred embodiment of the process of the invention component (A1) is introduced as an initial charge in stage (I) and is reacted with a mixture comprising components (B 1), (B2′), (B3′) and, where appropriate, (B4), (B5) and, where appropriate, components (B2″), (B3″) under anhydrous conditions in a temperature range from 50 to 100° C., preferably from 50 to 90° C. and more preferably from 50 to 80° C. in the presence of (C1). The components (B) may also be added individually and in any order. The amount of the components (B) is in each case such that following complete reaction of the OH/NH/NH₂ groups there remain, theoretically, no excess NCO or OH/NH/NH₂ groups.

With particular preference, the preparation of polyurethane in stage (I) of the process of the invention takes place in two stages, by first reacting the isocyanate component (A1) with a molar deficit of components (B1), (B3′) and, where appropriate, (B2′) or with part of the amount of (B2′) in the presence of (C1) to give an NCO prepolymer having an NCO content of from 0.2 to 4% by weight, preferably from 0.5 to 3% by weight and more preferably from 0.6 to 2.0% by weight. In a second, subsequent step, the NCO prepolymer is reacted fully with (B2′) or with the remaining part of the amount of component (B2′) so that the NCO:OH/NH/NH₂ ratio is 1:1.

Where a polyurethane containing urea groups is to be prepared it is preferred to add the components that can be used as amino-functional compounds (B3″), (B4) and (B5) in the second step of the polyurethane preparation.

For the preparation of coating compositions the polyurethane-polyacrylate hybrid dispersions of the invention are used either alone or in combination with other aqueous binders. Such aqueous binders may be composed, for example, of polyester, polyacrylate, polyepoxide or polyurethane polymers. Also possible is the combination with radiation-curable aqueous binders, as described fundamentally, for example, in EP-A 0 753 531 (p. 2, line 44-p. 6, line 49), EP-A 0 872 502 (p. 3, line 4-p. 12, line 19) and EP-A 0 942 022 (p. 4, line 18-p. 17, line 57).

It is additionally possible to add crosslinkers before applying the coating composition comprising the polyurethane-polyacrylate hybrid dispersions of the invention. Examples of suitable crosslinkers are di- or polycarbodiimides, di- or polyaziridines. Hydrophilic and hydrophobic polyisocyanate crosslinkers are preferred. Moreover, it is possible to add blocked polyisocyanates to the polyurethane-polyacrylate hybrid dispersions of the invention and to cure them under thermal conditions. Furthermore, the polyurethane-polyacrylate hybrid dispersions can also be cured thermally by using melamine resins. A combination of melamine resins and blocked polyisocyanates is likewise possible.

To prepare the coating compositions the polyurethane-polyacrylate hybrid dispersions of the invention may be included in a formulation by being used as they are or in combination with the auxiliaries and additives known from coating technology, such as fillers, pigments, solvents, levelling assistants, for example. The invention also provides use of the polyurethane-polyacrylate hybrid dispersions of the invention by including them in a formulation for coating substrates. Suitable substrates are selected from the group consisting of plastics, metals, glasses, paper, woods, textiles, leather, felt, mineral articles or precoated substrates. Preferred substrates are wood and plastic. The substrates are coated by knife coating, dipping pouring, spraying, squirting or brushing and subsequent drying at from 10 to 100° C., preferably from 20 to 80° C.

The invention further provides for the use of the polyurethane-polyacrylate hybrid dispersions of the invention by including them in a formulation for producing a strippable coating, which can be used, for example, for the temporary protection of glass, plastics, or paints. For this purpose it is preferred to use polyurethane-polyacrylate hybrid dispersions that are free of urea groups.

The polyurethane-polyacrylate hybrid dispersions of the invention may likewise be included in a formulation and used for preparing paints or adhesives.

### EXAMPLES

### Example 1 (Inventive)

226.1 g of a polyester synthesized from adipic acid, 1,6-hexanediol and neopentylglycol (1.6 parts by weight of hexanediol, 1 part by weight of neopentylglycol) having a molecular weight of 1700 g/mol, 21.9 of dimethlyolpropionic acid and 11.2 g of 1,4-butanediol are dewatered at 80° C. under reduced pressure for 1 hour. The solution is cooled to 60° C. for 15.6 g of butylglycol and a monomer mixture (I) consisting of 78.0 g of butyl acrylate, 58.0 g of methyl methacrylate, 21.6 g of styrene and 0.6 g of 2,6-di-tert-butyl-4-methylphenol (BHT) is added with stirring. Following homogenization, 134.5 g of isophorone diisocyanate are added over the course of 5 minutes. The temperature is held at 70° C. until the theoretical NCO content of 1.8% has been reached. Then 10.7 g of 1,4-butanediol are added and the reaction is continued until the NCO reaches zero. Thereafter 16.5 g of triethylamine and, after 10 minutes of incorporation by stirring, 1089 g of hot water at 35° C. are added over the course of 10 minutes, with vigorous stirring. The dispersion is homogenized at mixing temperature for 10 minutes more before being heated to 50° C. and 2.8 g of a solution (I) dissolved in 157.5 g of water is added parallel to 160.2 g of a solution (II). Following this, at 50° C., 15.9 g of a solution (III) are added over the course of 5 minutes and the constituent is stirred for 30 minutes, before 143.2 g of the solution (III) are added in parallel with the monomer mixture (II) over the course of 1 hour at 50° C. Stirring is continued at 50° C. for one hour more and the mixture is cooled to room temperature and filtered.

| Solution (I): | 0.4 g of iron (II) sulphate and 0.38 of |
|---|---|
| | Trilon ® B (Na salt of EDTA, BASF AG, |
| | Ludwigshafen, DE) dissolved in 77 g of |
| | water |
| Solution (II): | 3.2 g of Trigonox ® A-W 70 (tert-butyl |
| | hydroperoxide, Akzo Nobel, Düren, DE) |
| | dissolved in 157.5 g of water |
| Solution (III): | 1.6 g of Rongalit ® C (Na salt of |
| | hydroxymethanesulfinic acid, BASF AG, |
| | Ludwigshafen, DE) dissolved in 157.5 g |
| | of water |
| Monomer mixture (I): | 64.7 g of styrene, 233.9 g of butyl |
| | acrylate, 173.9 g of methyl methacrylate |
| Solids content: | 38.8% |
| Average particle size (APS): | 51 nm (laser correlation spectroscopy |
| | (LCS)) |
| pH: | 7.5 |

### Example 2 (Inventive)

Except for the addition of the water, the preparation takes place as specified under Example 1. The dispersion is homogenized at mixing temperature for 10 minutes more, before being heated to 75° C., and 13.2 g of a 5% strength aqueous ammonium peroxodisulphate solution are added dropwise over the course of 5 minutes. The mixture is held at 75° C. for 30 minutes, before 63.6 g of a 1% strength aqueous ammonium peroxodisulphate solution are added over the course of one hour in parallel with the monomer mixture (II) at 75° C. Finally, stirring is continued at 50° C. for one hour more and the mixture is cooled to room temperature and filtered.

| Monomer mixture (II): | 64.7 g of styrene, 233.9 g of butyl acrylate, 173.9 |
|---|---|
| | g of methyl methacrylate |
| Solids content: | 39.4% |
| APS (LCS): | 134 nm |
| pH: | 7.4 |

TABLE 1
Inventive Examples 3 to 7 (preparation as for Ex. 1)

| Example | 3 | | 4 | | 5 | | 6 | | 7 | |
|---|---|---|---|---|---|---|---|---|---|---|
| Polyester | 226.1 | g | 226.1 | g | 267.8 | g | 282.2 | g | 282.2 | g |
| DMPA | 21.9 | g | 21.9 | g | 35.2 | g | 25.5 | g | 25.5 | g |
| 1,4-Butanediol (1^{st} part) | 11.2 | g | 15.2 | g | 28.7 | g | 14.2 | g | 14.2 | g |
| Butylglycol | 15.6 | g | 5.2 | g | 39.9 | g | — | | — | |
| Monomer mixture (I) | | | | | | | | | | |
| Butyl acrylate | 28.8 | g | 76.8 | g | 82.7 | g | 87.8 | g | 67.4 | g |
| Methyl methacrylate | 21.4 | g | 57.1 | g | 61.5 | g | 65.2 | g | 86.0 | g |
| Styrene | 8.0 | g | 21.2 | g | 22.9 | g | 24.3 | g | 23.9 | g |
| BHT | 0.2 | g | 0.6 | g | 0.2 | g | 0.7 | g | 0.7 | g |
| IPDI | 134.5 | g | 134.5 | g | 269.4 | g | 140.3 | g | 140.3 | g |
| 1,4-Butanediol (2^{nd} part) | 10.7 | g | 10.7 | g | 27.3 | g | 10.6 | g | 10.6 | g |
| Triethylamine | 16.5 | g | 16.5 | g | 26.5 | g | 19.2 | g | 19.2 | g |
| Monomer mixture (II) | | | | | | | | | | |
| Styrene | 26.3 | g | 63.8 | g | | | 61.6 | g | 59.8 | g |
| Butyl acrylate | 94.9 | g | 230.7 | g | | | 222.7 | g | 168.3 | g |
| Methyl methacrylate | 70.6 | g | 171.5 | g | | | 165.6 | g | 214.8 | g |
| Solution (I) // | 1.1 | g // | 2.8 | g // | 0.8 | g // | 2.7 | g // | 2.7 | g // |
| in × g of H₂O | 63.9 | | 124 | | 41.8 | | 150 | | 148 | |
| Solution (II) | 65.2 | g | 127.0 | g | 42.6 | g | 153.0 | g | 150.6 | g |
| Solution (III) | 64.6 | g | 125.5 | g | 42.2 | g | 151.5 | g | 149.1 | g |
| Water | 867.0 | g | 1230.0 | g | 1102.0 | g | 1225.0 | g | 1225.0 | g |
| Solids content [%] | 38.1 | | 39.8 | | 39.8 | | 40.3 | | 39.8 | |
| APS | 53 | nm | 129 | nm | 144 | nm | 130 | nm | 122 | nm |

| | | | | | |
|---|---|---|---|---|---|
| pH | 7.5 | 7.8 | 7.8 | 7.8 | 7.7 |

### Example 8 (Inventive)

226.1 g of a polyester synthesized from adipic acid, 1,6-hexanediol and neopentylglycol (1.6 parts by weight of hexanediol, 1 part by weight of neopentylglycol) having a molecular weight of 1700 g/mol, 21.9 of dimethlyolpropionic acid and 11.2 g of 1,4-butanediol are dewatered at 80° C. under reduced pressure for 1 hour. The solution is cooled to 60° C. for 15.6 g of butylglycol and a monomer mixture (I) of 39.9 g of butyl acrylate, 65.1 g of methyl methacrylate and 0.5 g of 2,6-di-tert-butyl-4-methylphenol (BHT) is added with stirring. Following homogenization, 134.5 g of isophorone diisocyanate are added over the course of 5 minutes. The temperature is held at 70° C. until the theoretical NCO content of 1.8% has been reached. Then 10.7 g of 1,4-butanediol are added and the reaction is continued until the NCO reaches zero and subsequently 16.5 g of triethylamine are added. The mixture is added over the course of 5 minutes with vigorous stirring to 1680.0 g of water conditioned to 35° C. The dispersion is homogenized at mixing temperature for 10 minutes more before being heated to 60° C. and is admixed over the course of 5 minutes with 48.2 g of a solution (I). The mixture is stirred at 60° C. for 30 minutes and subsequently, over the course of one hour and in parallel, 192.8 g of solution (I) and 734.8 g of the monomer mixture (II) are added. Finally the mixture is stirred at 70° C. for one hour more, cooled to room temperature and filtered.

| Solution (I): | dissolve 4.8 g of 4,4′-azobis-4-cyanopentanoic |
|---|---|
| | acid in 236.2 g of water and adjust to a pH of 8.2 |
| | using triethanolamine |
| Monomer mixture (II): | 279.2 g of butyl acrylate, 455.6 g of methyl |
| | methacrylate |
| Solids content: | 40.0% |
| APS (LCS): | 37 nm |
| pH | 8.5 |

### Example 9 (Inventive)

225.9 g of a polyester synthesized from adipic acid, 1,6-hexanediol and neopentylglycol (1.6 parts by weight of hexanediol, 1 part by weight of neopentylglycol), having a molecular weight of 1700 g/mol, 21.9 of dimethlylol-propionic acid and 5.4 g of 1,3-butanediol are dewatered at 80° C. under reduced pressure for 1 hour. The solution is cooled to 60° C.; 30.8 g of butylglycol and a monomer mixture (I) are added with stirring and, following homogenization, 134.5 g of isophorone diisocyanate are added over the course of 5 minutes. The temperature is held at 70° C. until the theoretical NCO content of 1.8% has been reached. Then 65.6 g of an aspartic ester prepared from 1 mol of 4,4′-diamino-dicyclohexylmethane and 2 mol of diethyl maleate (preparation in analogy to DE-A 197 17 427, Ex. 5) are added and the reaction is continued until the NCO of zero has been reached, before 16.5 g of triethylamine are added and are incorporated by stirring for 15 minutes. Subsequently, the mixture is added over the course of 5 minutes with vigorous stirring to 1134.0 g of water conditioned at 35° C. The dispersion is homogenized at mixing temperature for a further 10 minutes, before being heated to 50° C. Over the course of 5 minutes, 314 g of a solution (I) are added in parallel with 314 g of a solution (II). Thereafter, at 50° C., 15.4 g of a solution (III) are added over the course of 5 minutes and the constituent is stirred for 30 minutes, before a further 141.7 g of the solution (III) is added in parallel with the monomer mixture (II) over the course of 1 hour at 50° C. Finally, the reaction mixture is stirred at 70° C. for one hour more, cooled to room temperature and filtered.

| Solution (I): | 2.0 g of iron (II) sulphate and 2.0 g of |
|---|---|
| | Trilon ® B (BASF AG, Ludwigshafen, DE) |
| | dissolved in 310 g of water |
| Solution (II): | 4.3 g of Trigonox ® A-W 70 (Akzo Nobel, |
| | Düren, DE) dissolved in 310 g of water |
| Solution (III): | 2.3 g of Rongalit ® C (BASF AG, |
| | Ludwigshafen, DE) dissolved in 155 g of water |
| Monomer mixture (I): | 22.8 g of butyl methacrylate, 108.0 of methyl |
| | methacrylate and 0.4 g of 2,6-di-tert-butyl-4- |
| | methyl-phenol (BHT) |
| Monomer mixture (II): | 57.7 g of butyl methacrylate, 219.9 g of methyl |
| | methacrylate |
| Solids content: | 32.0% |
| APS (LCS): | 44 nm |
| pH | 7.7 |

### Comparative Example 10

282.2 g of a polyester synthesized from adipic acid, 1,6-hexanediol and neopentylglycol (1.6 parts by weight of hexanediol, 1 part by weight of neopentylglycol), having a molecular weight of 1700 g/mol, 24.3 of dimethlyolpropionic acid, 9.5 g of 1,4-butanediol are dewatered at 80° C. under reduced pressure for 1 hour. The solution is cooled to 60° C.; the monomer mixture (I) composed of 23.1 g of styrene, 83.6 g of butyl acrylate, 62.2 of methyl methacrylate and 0.7 g of 2,6-di-tert-butyl-4-methylphenol (BHT) are added with stirring, before 134.5 g of isophorone diisocyanate are added over the course of 5 minutes. The temperature is held at 70° C. until the theoretical NCO content of 2.1% has been reached. Then 16.5 g of triethylamine are added. The mixture has added to it over the course of 5 minutes, with vigorous stirring, 1229.3 g of water conditioned to 35° C. The dispersion is homogenized at mixing temperature for 5 minutes more, before a solution of 1.8 g of hydrazine hydrate, 5.1 g of ethylenediamine and 51.4 g of water is added. Stirring is carried out at 50° C. until NCO is no longer detectable. (IR method). Thereafter, over the course of 5 minutes, 3.0 g of the solution (I) dissolved in 143 g of water and 146.7 g of a solution (II) are added. The mixture is stirred at 50° C. for 30 minutes following which 17 g of the solution (III) are added over the course of 10 minutes and the constituents are stirred for 30 minutes. Then, at 50° C., over the course of one hour and in parallel, 153.6 g of the solution (III) and 506.2 g of a monomer mixture (II) (69.4 g of styrene, 250.9 g of butyl acrylate and 186.5 g of methyl methacrylate) are added. The mixture is then stirred at 50° C. for one hour more, cooled to room temperature and filtered.

| Solution (I): | 0.32 g of iron (II) sulphate and 1.52 of Trilon ® B |
|---|---|
| | (BASF AG, Ludwigshafen, DE) dissolved in 310 g |
| | of water |
| Solution (II): | 3.4 g of Trigonox ® A-W 70 (Akzo Nobel, Düren, |
| | DE) dissolved in 143.2 g of water |
| Solution (III): | 1.7 g of Rongalit ® C (BASF AG, Ludwigshafen, |
| | DE) dissolved in 169 g of water |
| Solids content: | 38.0% |
| APS (LCS): | 17 nm |
| pH: | 8.0 |

### Comparative Example 11

226.1 g of a polyester synthesized from adipic acid, 1,6-hexanediol and neopentylglycol (1.6 parts by weight of hexanediol, 1 part by weight of neopentylglycol), having a molecular weight of 1700 g/mol and 21.9 of dimethlyolpropionic acid are dewatered at 80° C. under reduced pressure for 1 hour, before 15.2 g of 1,4-butanediol and 5.2 g of butylglycol are added. The solution is cooled to 60° C.; the monomer mixture (I) composed of 20.7 g of styrene, 74.8 g of butyl acrylate, 55.6 of methyl methacrylate and 0.6 g of 2,6-di-tert-butyl-4-methylphenol (BHT) are added with stirring, then 134.5 g of isophorone diisocyanate is added over the course of 5 minutes. The temperature is held at 70° C. until the theoretical NCO content of 1.8% has been reached. Then 16.5 g of triethylamine are added. The mixture has added to it over the course of 5 minutes, with vigorous stirring, 1092 g of water conditioned to 35° C. The dispersion is homogenized at mixing temperature for 5 minutes more, before a solution of 1.4 g of hydrazine hydrate, 4.0 g of ethylenediamine and 40 g of water is added. Stirring is carried out at 50° C. until NCO is no longer detectable. (IR method). Thereafter, over the course of 5 minutes, 2.7 g of the solution (I) dissolved in 131.2 g of water and 134.1 g of a solution (II) are added. The mixture is stirred at 50° C. for 30 minutes following which 15 g of the solution (III) are added over the course of 10 minutes and the constituents are stirred for 30 minutes. Then, at 50° C., over the course of one hour and in parallel, 138.6 g of the solution (III) and 453 g of a monomer mixture (II) (62.1 g of styrene, 224.4 g of butyl acrylate and 166.8 g of methyl methacrylate) are added. The mixture is stirred at 50° C. for one hour more, cooled to room temperature and filtered.

Composition of the solutions I-III: See Ex. 9

| | |
|---|---|
| Solids content: | 39.7% |
| APS (LCS): | 94 nm |
| pH: | 7.5 |

### Performance Examples

### Example 12 (Strippability)

100 g of the product from Example 1, Example 4 or Example 6 are admixed with 0.5 g of a standard commercial silicone-free substrate wetting agent (Hydropalat® 110, Cognis & Inks, Düsseldorf, DE) and the constituents are stirred together. The mixture is knife coated (210μwet drawdown) onto a glass plate which has been cleaned with acetone and dried. The coating is flashed off at room temperature for 10 minutes before being subjected to forced drying at 80° C. for a further 10 minutes. After 24 hours the elastic product can be detached from the glass plate easily without tearing. It is even easier to remove the coating applied by the same method to a clearcoat (2-component polyurethane clearcoat from Audi, from OEM finishing). The elongation at break of the coating, determined manually, is 350% when using the dispersion 1 obtained in accordance with Example 1 and 300% in the case of the dispersions obtained in accordance with Examples 4 and 6.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing aqueous, emulsifier-free and solvent-free polyurethane-polyacrylate hybrid dispersions, comprising the steps of
(I) preparing a hydrophilic or hydrophilicizable polyurethane by reacting one or more isocyanate components (A) with one or more components (B) comprising
(B1) one or more diols or polyols having a molecular weight of from 500 to 6000 and an OH functionality of from 1.8 to 5,
(B2) one or more low molecular weight diols or polyols of the molecular weight range from 62 to 400 with an OH functionality of two or more as chain extenders,
(B3) one or more hydrophilic compounds containing non-ionic groups and/or ionic and/or potentially ionic groups and having at least one NCO-reactive group,
in the presence of ethylenically unsaturated monomers (C1) which are inert towards NCO groups, with the proviso that components (A) and (B) are used so as to result in a ratio of NCO groups to OH/NH/NH₂ groups of 1:1,
(II) subsequently dispersing the polyurethane from (I) in water, and
(III) emulsion-polymerizing monomers (C) comprising one of
(i) ethylenically unsaturated monomers (C1) inert towards NCO groups and
(ii) ethylenically unsaturated monomers (C1) inert towards NCO groups and ethylenically unsaturated monomers (C2) containing Zerevitinov-active hydrogen atoms.

2. Process according to claim 1, wherein the isocyanate component (A) in step (I) comprises diisocyanates (A1) selected from the group consisting of 4,4′-diisocyanatodiphenylmethane, 2,4-diisocyanatodiphenylmethane, 2,4-diisocyanatotoluene, 2,6-diisocyanatotoluene and mixtures thereof.

3. Process according to claim 1, wherein the isocyanate component (A) in step (I) comprises diisocyanates (A1) selected from the group consisting of 1,6-hexamethylene diisocyanate, 1-isocyanato-3,3,5-trimethyl-5-isocyanatomethylcyclohexane (isophorone diisocyanate), 4,4′-diisocyanatodicyclohexylmethane and mixtures thereof.

4. Process according to claim 1, wherein component (B 1) comprises at least one of α,Ω-diols of polyesters, polyethers based on propylene oxide or tetrahydrofuran, polyester carbonates and polycarbonates.

5. Process according to claim 4, wherein component (B1) is a polyester based on adipic acid, 1,6-hexanediol and neopentylglycol.

6. Process according to claim 1, wherein component (B2) is selected from the group consisting of ethylene glycol, 1,2-propanediol, 1,3-propanediol, 1,3-butanediol, 1,4-butanediol, 1,6-hexanediol, 2-ethyl-1,3-hexanediol, diethylene glycol, dipropylene glycol, neopentylglycol, 2,4-dimethylpentanediol, 2-ethyl-3-propyl-1,5-pentanediol, 2,2,4-trimethylpentanediol, cyclohexanedimethanol and mixtures of these diols.

7. Process according to claim 1, wherein component (B3) is ionic or potentially ionic compounds.

8. Process according to claim 1, wherein component (C) is composed of from 50 to 100% by weight of ethylenically unsaturated monomers (C1).

9. Polyurethane-polyacrylate hybrid dispersions obtained by the process of claim 1.

10. Polyurethane-polyacrylate hybrid dispersions according to claim 9, wherein the polyurethane is free of urea groups.

11. Coating composition comprising the polyurethane-polyacrylate hybrid dispersions according to claim 9.

12. Method for coating substrates, comprising coating substrates with polyurethane-polyacrylate hybrid dispersions according to claim 9.

13. Method for preparing a strippable coating material comprising including polyurethane-polyacrylate hybrid dispersions according to claim 10 in a formulation.

14. Method for preparing paints or adhesives, comprising including polyurethane-polyacrylate hybrid dispersions according to claim 9 in a formulation.

15. The process of claim 1, wherein the components (B) further comprise
(B4) if desired, one or more polyamines and/or alkanolamines of the molecular weight range from 60 to 300 with an NH functionality of 2 or more,
(B5) if desired, monofunctional compounds of the molecular weight range from 17 to 350.
